(19) United States
(12) Patent Application Publication
(10) Pub. No.: US 2011/0150622 A1
(43) Pub. Date: Jun. 23, 2011

(54) METHOD AND APPARATUS FOR TRANSPORTING MAIL

(76) Inventors: Wolfgang Schwarz, Longboat Key, FL (US); Michael O. Norris, Colleyville, TX (US)

(21) Appl. No.: 12/969,733

(22) Filed: Dec. 16, 2010

Related U.S. Application Data
(63) Continuation-in-part of application No. 12/800,813, filed on May 21, 2010.
(60) Provisional application No. 61/180,531, filed on May 22, 2009.

(51) Int. Cl. B65G 67/02; B62B 3/02; B62B 3/10

(52) U.S. Cl. 414/800; 280/35

(57) ABSTRACT

A method for mail handling, and a mail extraction cart. The mail extraction cart has a chassis formed by a wheeled base supporting a pair of lower support members and a pair up upper support members connected to the lower support members. The cart has a column of support shelves between each of the pair of upper support members and each of the pair of lower support members, the support shelves movable between at least a first position and a second position. The cart has a lever to control the position of the support shelves. In the first position, the support shelves are configured to engage a plurality of bins of a sorting machine. In the second position, the support shelves are configured to remove the plurality of bins from the sorting machine to be carried by the mail extraction cart.

### CROSS-REFERENCE TO OTHER APPLICATION

This application is a continuation-in-part of U.S. patent application Ser. No. 12/800,813, filed May 21, 2010, which is hereby incorporated by reference. This application also claims the benefit of the filing date of U.S. Provisional Patent Application 61/180,531, filed May 22, 2009, which is hereby incorporated by reference.

### TECHNICAL FIELD

The invention relates to mail transport carts for use in a postal sorting facility as currently operated by the U.S. Postal Service (USPS).

### BACKGROUND OF THE DISCLOSURE

Improved devices and processes for transporting mail are desirable.

### SUMMARY OF THE DISCLOSURE

Various disclosed embodiments include a method for mail handling and a mail extraction cart. The mail extraction cart has a chassis formed by a wheeled base supporting a pair of lower support members and a pair of upper support members connected to the lower support members. The cart has a column of support shelves between each of the pair of upper support members and each of the pair of lower support members, the support shelves movable between at least a first position and a second position. The cart has a lever to control the position of the support shelves. In the first position, the support shelves are configured to engage a plurality of bins of a sorting machine. In the second position, the support shelves are configured to remove the plurality of bins from the sorting machine to be carried by the mail extraction cart.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a portion of a sorting machine;

FIGS. 2-7 depict extraction carts in accordance with disclosed embodiments; and

FIG. 8-10 shows a schematic representation of a compression mechanism in accordance with disclosed embodiments.

### DETAILED DESCRIPTION

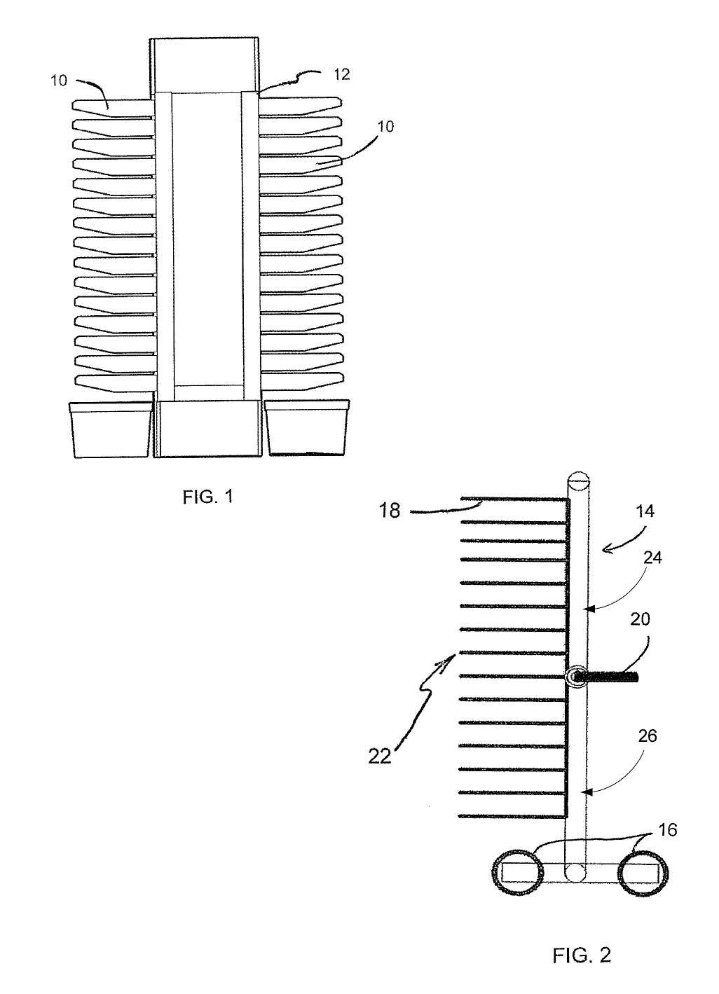

FIGS. 1 through 10 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

The USPS carries out mail sorting operations using automated sorting machines which include destination bar code sorter (DBCS) and Multiline Optical Character Reader (MLOCR) machines. These sorters can include a feeder which feeds letters one at a time into a pinch belt conveyor system which transports each mail piece past a scanner or image lift camera that scans one or both faces of the mail piece for destination indicia, i.e. a printed bar code or address which can be read using optical character recognition. The mail is sorted automatically into pockets of a stacker, which are manually swept by postal workers, who put the contents into trays. The trays are then put onto carts for the next stage of postal processing. The cart currently used for this purpose, known as the 1226, is described further below.

Another commonly used cart in postal facilities for transport of mail in trays is the all purpose container (APC), which comprises a pair of barred cages open at the front in which mail trays are stacked, often in an irregular manner. The bottom cage is mounted on wheels. It is approximately six feet high, two feet wide, and three and a half feet long. It weighs over 200 pounds empty and may carry over 800 pounds of mail. The APC has an upper and lower compartment. There is at least one reported case of an injury involving an APC. That accidents can happen is not surprising considering the weight of the unit, its design and the amount of mail it can contain.

The size of the APC also limits or prevents its use sweepside, that is, next to a stacker where human workers are sweeping mail. For this purpose a smaller cart called the 1226 is used. The 1226 is likewise a steel frame, six-level cart. The top and bottom shelves are open. The four intermediate levels are each provided with a row of pull out shelves or slides. These take up considerable space, so the number of levels is limited to six total, with six shelves per row, limiting the middle levels of the cart to 24 trays of the plastic EMM type.

While a great variety of carts have been the subject of patents, none are well adapted to take the place of the 1226 in postal sweeping operations and for later transportation and unloading. See, for example, carts described in United States Patent Application 2009/0139913, hereby incorporated by reference.

Disclosed embodiments include a cart that can be loaded with bins of sorted mail directly onto a vehicle or into storage.

Some embodiments include a method for transporting sorted mail. Such a method includes sorting flat mail pieces from a sorting machine into a series of bins mounted on a rack, and removing the series of bins from the rack onto shelves of an extraction cart. The method includes moving the loaded cart onto a delivery vehicle, removing the bins from the cart into positions for delivery, removing the mail from the bins, and delivering the mail to the recipient.

Other embodiments include an apparatus including a cart for carrying out the methods described herein.

FIG. 1 depicts a block diagram of a portion of a sorting machine, such as the postal sorting machines described above. Is this figure, the bin wall 12 acts as a rack that supports a plurality of bins 10. The bins 10 are removably mounted on the bin wall 12, and can be on one or both sides of the sorting machine. The sorting machine sorts mail pieces in to the series of bins 10 mounted on the rack.

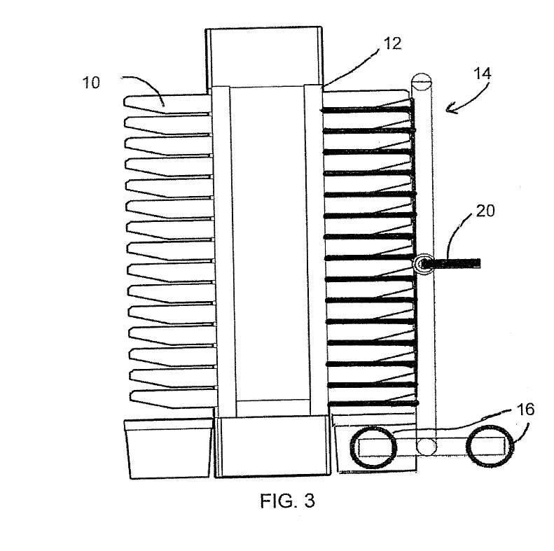

FIG. 2 depicts an extraction cart in accordance with disclosed embodiments, configured to and capable of removing bins 10 from the bin wall 12. Extraction cart 14 is movable by means of supporting wheels 16 attached to a wheeled base. The wheeled base supports pairs of upper support member 24 and lower support members 26, which together form a chassis. In this embodiment, extraction cart 14 has a series of horizontal plates 18 mounted to be raised and lowered together by a lever mechanism 20, and these plates support a stack of support shelves 22. Preferably, each of the support shelves has an upward-raised bin hook, not shown, for engaging and retaining a bin 10. Horizontal plates 18 are supported between opposite pairs of upper support member 24 and lower support members 26.

FIG. 3 shows an example of the extraction cart interacting with the bins in accordance with disclosed embodiments. In operation, a human worker rolls cart 14 to the left in FIG. 3 so that a column of support shelves 22 is inserted under bins 10. Typically, there will be a corresponding support shelf 22 for each bin 10, but other embodiments contemplate that only some of the bins may be removed at a single time using a fewer number of support shelves 22. The cart removes the series of bins from the rack to its shelves.

Lever 20 is turned to lift the support shelves 22. The support shelves 22 lift the bins 10 in the column, and retain them by means of the bin hooks.

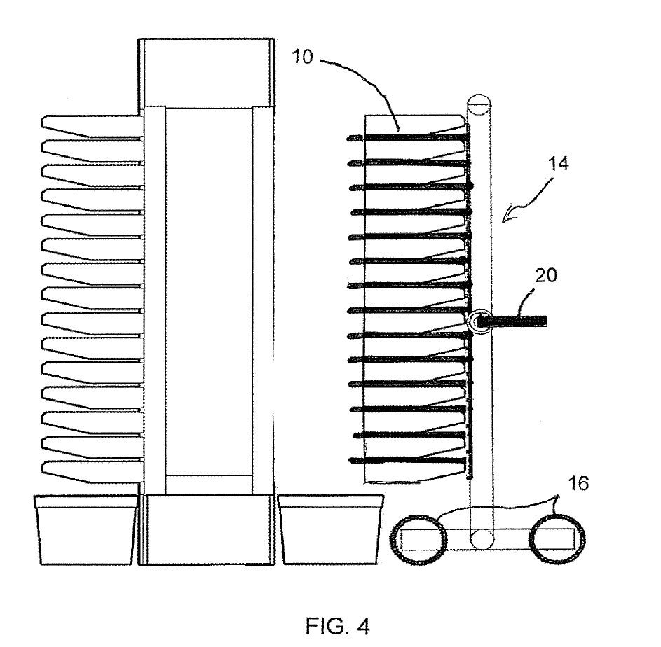

FIG. 4 depicts the cart 14 rolled backwards, loaded with bins 10.

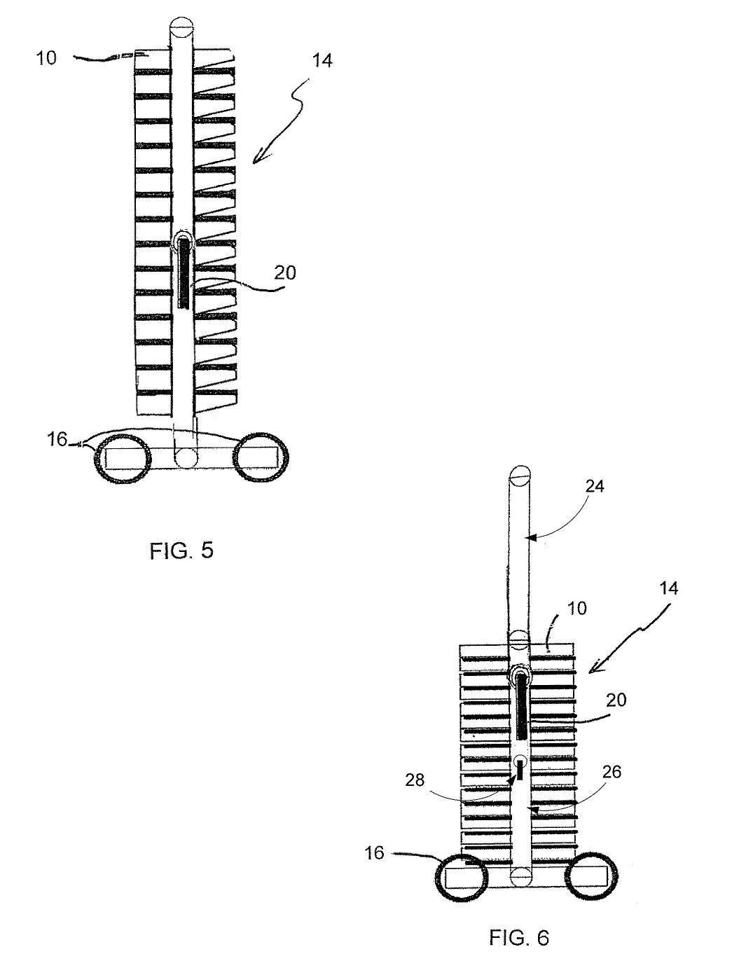

FIG. 5 depicts the cart 14 with the bins 10 positioned for transport. Handle 20 is fully rotated, which substantially centers the bins 10 on the cart 14. This allows the bins 14 to be supported by the plates 18 (not visible in this figure) or by support shelves 22 (also not shown in this figure). By moving the bins 10 to a substantially center position on cart 14, cart 14 is much more stable, and the bins are retained on the sides by the upper and lower support members of cart 14, preventing them from accidently falling off. The bins can also be lowered so that they are substantially stacked in the center position, as described below.

FIG. 6 shows the bins 10 in a lowered position for transport. In this figure, the bins 10 have been lowered so that they are substantially stacked on one another, lowering the center of gravity of the cart 14 and making the cart 14 more stable for transport. The bins can be lowered using the mechanisms described below, in some embodiments. In the lowered position, the bins 10 and their support mechanism are lowered into lower support member 26, apart from upper support member 24. Lowering the bins can be controlled, for example, by lowering mechanism 28, shown in this embodiment. Depending on how the compression mechanism is structured, as described below, the lowering mechanism can be implemented using a crank, a switch to control an electric motor, or otherwise.

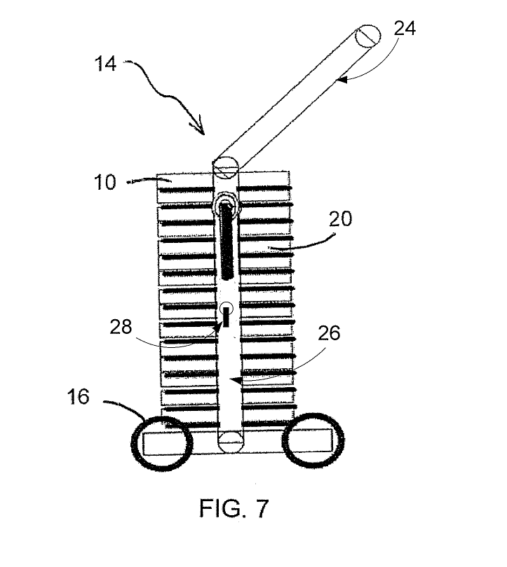

FIG. 7 shows the upper support members 22 of the cart 14 can be rotated into a lowered position when the bins 10 are in a lowered position in lower support members 26. In this way, the overall height of the cart 14 can be reduced for more efficient transport and storage. Further, upper support members 24 can include a crossbar (not shown from this perspective) that allow the combination of upper support members 24 and the crossbar to act as a handle for pushing, pulling, or otherwise moving the cart 14.

As described, the support shelves are movable between at least a first position and a second position. In the first position, the support shelves are configured to engage a plurality of bins of a sorting machine, and in the second position, the support shelves are configured to remove the plurality of bins from the sorting machine to be carried by the mail extraction cart. In some embodiments, the support shelves are also movable to a third position that is substantially centered on the cart for transport. In some embodiments, the support shelves are also movable to a fourth position that is lowered so that the support shelves are only between each of the pair of lower support members. In some cases, when the support shelves are in the fourth position, the pair of upper support members can be rotated with respect to the pair of lower support members, and can function as a handle for the extraction cart.

The loaded cart 14 could then be loaded onto a mail truck or other vehicle, or be used to transport the bins 10 to another location. Preferably the mail is unloaded into mail trays in the vehicle or other location, either on the floor or on shelves provided for that purpose. In some embodiments, mail trays can be stacked in a nested configuration. At the destination the bins can be from the cart into positions for delivery. The mail can be removed from the bins and delivered to the recipient.

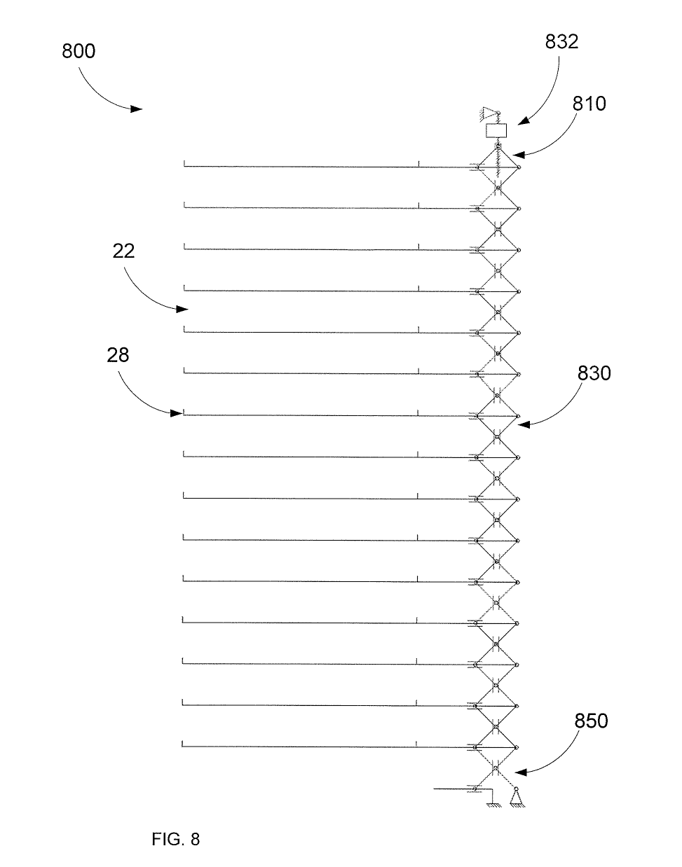

FIG. 8 shows a schematic representation of a compression mechanism 800 in the support members 24 and 26 that raises and lowers the support shelves 22. This compression mechanism can be used, in some embodiments, to lower the bins into a lowered, stacked position.

Shown here are support shelves 22, each having a bin hook 28. The compression mechanism ensures that the support shelves 22 all expand and compress in height with substantially equal spacing via the scissor action.

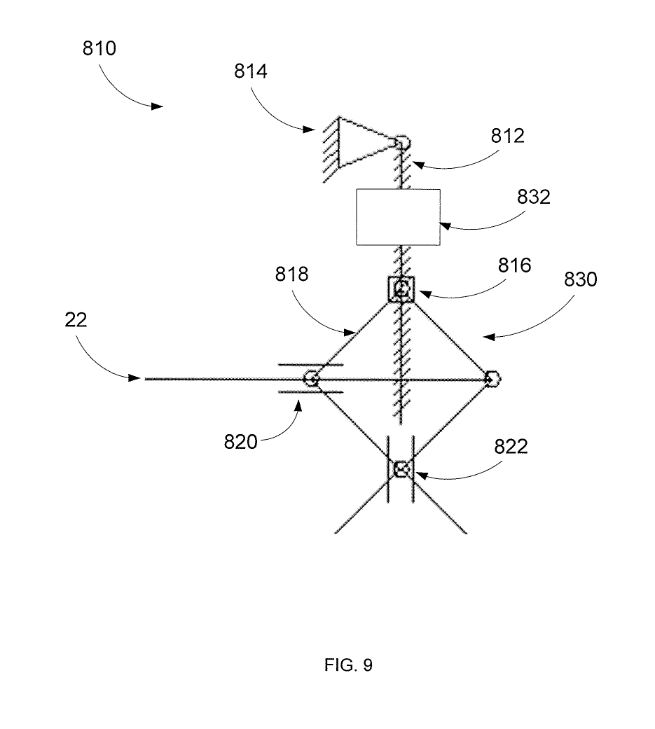

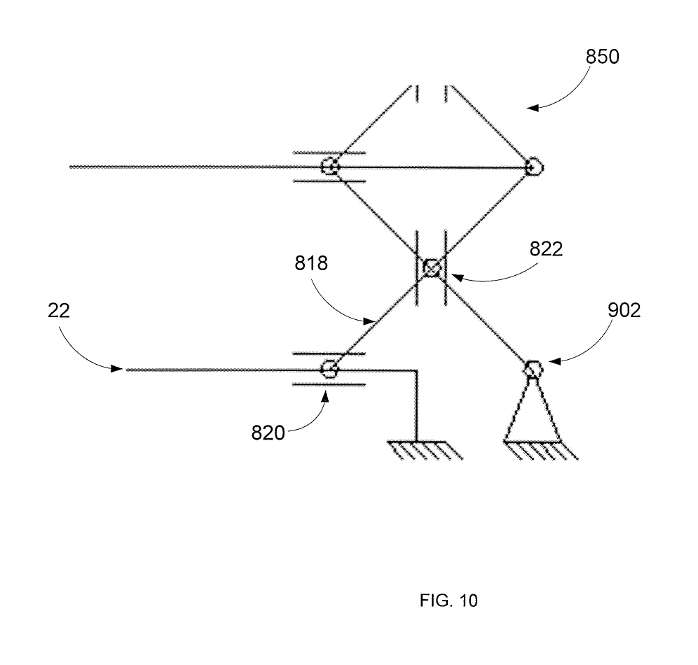

The compression mechanism includes a screw drive 810, a drive mechanism 832, and a scissor-and-slides mechanism 830, described in more detail below with relation to FIG. 9. The compression mechanism includes a base assembly 850, described in more detail below with relation to FIG. 10.

FIG. 9 shows a more detailed schematic representation of a screw drive for the compression mechanism. The screw drive includes a lead screw 812 that rotates to raise and lower nut 816. Nut 816 is connected to the lead screw 812 and to scissor links 818. Nut 816 supports the weight of all support shelves 22, hooks, and any bins 10 carried by the cart 14, and the nut 816 is supported and moved vertically by the lead screw 812.

The scissor links 818 are connected to support the support shelves 22. Lead screw 812 is connected to a bearing 814 that it itself connected to the chassis of the support members 24 and 26. The scissor links 818 are positioned to slide within horizontal pivot slides 820 at their connections, which can also act as tray hooks. Each of the nuts 816 are positioned to slide within vertical guides 822.

In some embodiments, drive mechanism 832 is configured to turn lead screw 812 to raise and lower nut 816, thereby compressing and expanding the support shelves 22. Drive mechanism 832 can be mechanical or electromechanical, in various embodiments, and details of various suitable structures are not shown here. For example, drive mechanism 823 can be a mechanical assembly that is operated using a crank as the lowering mechanism 28. In other embodiments, drive mechanism 823 can include an electric motor and power sourced, and can be operated using a switch as the lowering mechanism 28. Other variations of drive mechanisms capable of controllably turning the lead screw 812 are known to those of skill in the art. The positioning of the bearing 814, lead screw 812, drive mechanism 832, and nut 816 can vary in different embodiments. In embodiments where support members 24 and 26 do not rotate with respect to each other, all of these portions of the assembly can extend into upper support member 24. In other embodiments, various portions of the assembly must remain connected to lower support member 26 so that they can continue to operated even when upper support member 24 is in a rotated position.

FIG. 10 shows a more detailed schematic representation of a base assembly 850 for the compression mechanism. Shown in this figure are the support shelves 22, horizontal pivot slides 820, vertical guides 822, and scissor links 818 as shown in the figures discussed above. As illustrated in this figure, the lowermost scissor link 818 is connected to a fixed pivot 902 that is attached to the chassis of cart 14.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for transporting sorted mail, comprising:
sorting flat mail pieces from a sorting machine into a series of bins mounted on a rack;
removing the series of bins from the rack to shelves of an extraction cart;
moving the loaded cart onto a delivery vehicle;
removing the bins from the cart into positions for delivery; and
removing the mail from the bins and delivering the mail to the recipient.

2. A mail extraction cart comprising:
a chassis formed by a wheeled base supporting a pair of lower support members and a pair of upper support members connected to the lower support members;
a column of support shelves between each of the pair of upper support members and each of the pair of lower support members, the support shelves movable between at least a first position and a second position; and
a lever to control the position of the support shelves,
wherein in the first position, the support shelves are configured to engage a plurality of bins of a sorting machine, and
wherein in the second position, the support shelves are configured to remove the plurality of bins from the sorting machine to be carried by the mail extraction cart.

3. The mail extraction cart of claim 2, wherein the support shelves are also movable to a third position that is substantially centered on the cart for transport.

4. The mail extraction cart of claim 2, wherein the support shelves are also movable to a fourth position that is lowered so that the support shelves are only between each of the pair of lower support members.

5. The mail extraction cart of claim 4, wherein when the support shelves are in the fourth position, the pair of upper support members can be rotated with respect to the pair of lower support members.

6. The mail extraction cart of claim 4, wherein the pair of upper support members function as a handle for the extraction cart when rotated with respect to the pair of lower support members.

7. The mail extraction cart of claim 2, wherein the support shelves supported by a compression mechanism that adjusts the height of each of the plurality of support shelves.

8. The mail extraction cart of claim 7, wherein the compression mechanism comprises a scissor-and-slides mechanism that supports the plurality of support shelves, the scissor-and-slides mechanism connected to a screw drive that adjusts the height of each of the plurality of support shelves.

9. The mail extraction cart of claim 7, wherein the compression mechanism maintains the plurality of support shelves as substantially equidistant from each other.
